(19) United States
(12) Patent Application Publication
(10) Pub. No.: US 2026/0023603 A1
(43) Pub. Date: Jan. 22, 2026

(54) STORAGE ALLOCATION

(71) Applicant: Arm Limited, Cambridge (GB)

(72) Inventors: Jens OLSON, San Jose, CA (US); Jared Corey SMOLENS, Santa Clara, CA (US)

(21) Appl. No.: 18/778,188

(22) Filed: Jul. 19, 2024

(51) Int. Cl. G06F 9/50

(52) U.S. Cl. CPC G06F 9/5016; G06F 9/5038

(57) ABSTRACT

A processor comprising a storage unit comprising a plurality of storage elements. The processor is configured to obtain task data that describes a task to be executed, the task comprising a plurality of operations representable as a directed graph of operations comprising operations connected by connections corresponding to respective logical storage locations. A first connection associated with a first output of a first operation corresponds to a first logical storage location and a second connection associated with a second output of a second operation corresponds to a second logical storage location. The processor is configured to dynamically allocate a first set of the plurality of storage elements of the storage unit to correspond to the first logical storage location and a second set of the plurality of storage elements of the storage unit to correspond to the second logical storage location.

### BACKGROUND

### Technical Field

The disclosure herein relates to a processor and a method of handling data in a processor.

### Description of the Related Technology

An NPU (neural processing unit) is a specialized piece of hardware designed to optimize the performance of tasks related to artificial intelligence and neural networks. NPUs are increasingly common and are used for tasks such as autonomous driving and natural language processing, as well as face recognition, and voice recognition. NPUs typically include many processing elements and associated control structures that allow efficient processing of the numerous calculations in neural network and machine learning workloads.

GPUs (graphics processing units) were originally developed for rendering graphics in video games and multimedia applications. GPUs typically have hardware that is optimized for graphics processing tasks such as rendering graphics, simulating physics (e.g. ray tracing), and other tasks that require parallel processing. GPUs may also find applications in processing tasks relates to artificial intelligence and neural networks.

Data processing techniques, such as neural network processing and graphics processing, involve the processing and generation of considerable amounts of data. It is desirable to efficiently handle data such as this.

### SUMMARY

According to a first aspect of the present disclosure, there is provided a processor for handling data, the processor comprising a storage unit comprising a plurality of storage elements, the processor configured to: obtain task data that describes a task to be executed, the task comprising a plurality of operations representable as a directed graph of operations comprising operations connected by connections corresponding to respective logical storage locations, such that a first connection associated with a first output of a first operation of the plurality of operations corresponds to a first logical storage location and a second connection associated with a second output of a second operation of the plurality of operations corresponds to a second logical storage location; and dynamically allocate: a first set of the plurality of storage elements of the storage unit to correspond to the first logical storage location; and a second set of the plurality of storage elements of the storage unit to correspond to the second logical storage location.

According to a second aspect of the present disclosure, there is provided a method of handling data in a processor, the method comprising: obtaining task data that describes a task to be executed, the task comprising a plurality of operations representable as a directed graph of operations comprising operations connected by connections corresponding to respective logical storage locations, such that a first connection associated with a first output of a first operation of the plurality of operations corresponds to a first logical storage location and a second connection associated with a second output of a second operation of the plurality of operations corresponds to a second logical storage location; and dynamically allocating: a first set of a plurality of storage elements of the storage unit to correspond to the first logical storage location; and a second set of the plurality of storage elements of the storage unit to correspond to the second logical storage location.

### BRIEF DESCRIPTION OF THE DRAWINGS

FIG. 1a illustrates an example directed graph;

FIG. 1b is a schematic diagram of an example data processing system;

FIG. 2 is a schematic diagram of an example neural engine;

FIG. 3 is a schematic diagram of an example system for allocating handling data;

FIG. 4 is a schematic diagram of example storage;

FIG. 5 is a flow diagram showing an example method of handling data in a processor;

FIG. 6 is a schematic diagram of a linked list for tracking storage allocation according to an example;

FIG. 7 is a table showing per buffer controls for storage allocation;

FIG. 8 is a table showing per sub-pipe controls for storage allocation; and

FIG. 9 is a schematic diagram of manufacture of a system and a chip-containing product.

### DETAILED DESCRIPTION

Examples herein relate to a processor comprising a storage unit comprising a plurality of storage elements. The processor is configured to obtain task data that describes a task to be executed, the task comprising a plurality of operations representable as a directed graph of operations comprising operations connected by connections corresponding to respective logical storage locations. A first connection associated with a first output of a first operation corresponds to a first logical storage location and a second connection associated with a second output of a second operation corresponds to a second logical storage location. The processor is configured to dynamically allocate a first set of the plurality of storage elements of the storage unit to correspond to the first logical storage location and a second set of the plurality of storage elements of the storage unit to correspond to the second logical storage location.

This provides a way for multiple connections to share the same region of the storage unit, as respective storage elements of the storage unit (which may be within the same region of the storage unit) can be dynamically allocated to correspond to different respective logical storage locations, which themselves correspond to different respective connections of the directed graph. A plurality of operations can thus write to the same physical region of the storage.

Dynamic allocation of the storage elements may provide a more efficient use of the storage unit than otherwise. For example, the storage unit may be smaller than in other cases in which storage elements of the storage unit are statically allocated to correspond to different logical storage locations for storing the output of different respective operations.

A region of the storage unit comprising the storage elements to be allocated to a predefined set of connections (such as the first and second connections) may itself be dynamically allocated during execution of a directed graph of operations, to further improve flexibility and efficiency of use of the storage unit.

### Execution of a Directed Graph

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph is a data structure of operations (which may be referred to herein as ‘sections’) having directed connections therebetween that indicate a flow of operations. The connections between operations (or sections) present in the graph of operations may be referred to as pipes (where a given connection is the sole tenant of a particular region of the storage unit, which region may be allocated to that connection statically or dynamically) or sub-pipes (where a given connection shares a particular region of the storage unit with at least one other connection). The allocation of particular storage elements within a given region of the storage unit to different respective sub-pipes that are tenants of the given region of the storage unit may be performed dynamically. A plurality of sub-pipes may belong to the same pipe as each other, which may be referred to as a multi-pipe. In such cases, the multi-pipe may be the sole tenant of the given region of the storage unit, which may itself be statically or dynamically allocated to the multi-pipe. A directed graph may contain any number of divergent and convergent branches.

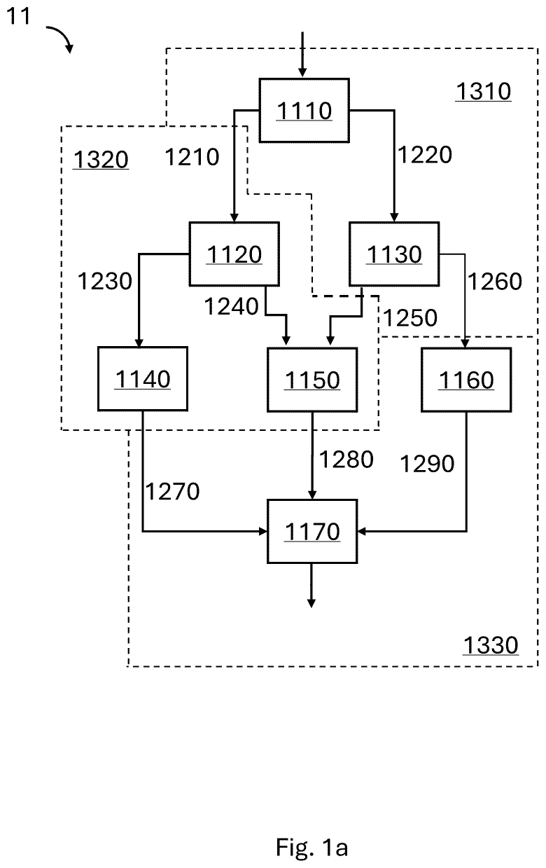

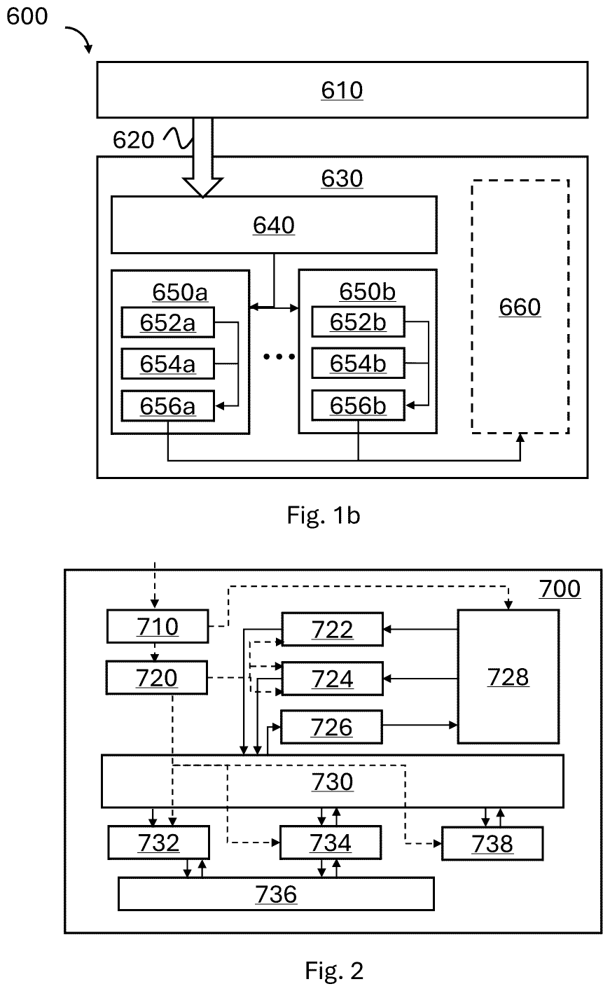

FIG. 1a illustrates an example directed graph 11 in which sections are interconnected by pipes or sub-pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe or sub-pipe. In FIG. 1a, sections 2 and 3 (1120, 1130) each write to different respective sub-pipes (1230, 1240, 1250, 1260) of the same pipe, pipe 3, which is a multi-pipe. Each sub-pipe has its own unique identifier, which also indicates the multi-pipe to which the sub-pipe belongs, where a multi-pipe is a pipe comprising at least one sub-pipe, as explained above. In this case, section 2 writes to sub-pipes 3.0 and 3.1 (1230, 1240) and section 3 writes to sub-pipes 3.2 and 3.3 (1250, 1260), where the numeral prior to the period indicates the identifier of the multi-pipe (3) and the numeral after the period indicates the identifier of the sub-pipe of the multi-pipe (0 to 3 in this case). A region of a storage unit is allocated to multi-pipe 3, and respective storage elements of the region of the storge unit are dynamically allocated to sub-pipes 3.0 to 3.3. In this example, different sections (sections 2 and 3) thus write to the same underlying physical region of the storage unit, via dynamically allocated sub-pipes.

The directed graph 11 of FIG. 1a also includes sections 4 to 6 (1140 to 1170) and pipes 4 to 6 (1270 to 1290). The sections 4 and 6 (1140, 1160) receive input data from sub-pipes 3.0 and 3.3 (1230, 1260) respectively, and write data to pipes 4 and 6 (1270, 1290) respectively. Section 5 (1150) in FIG. 1a receives a first set of input data via sub-pipe 3.1 (1240) from section 2 (1120) and a second set of input data via sub-pipe 3.2 (1250) from section 3 (1130) and writes data to pipe 5 (1280). Section 7 (1170) of the directed graph 11 receives input data from pipes 4 to 6 (1270 to 1290). Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 1a illustrates an arrangement where the graph 11 is broken down into three sub-graphs 1310, 1320, and 1330 which can be connected together to form the complete graph. For example, sub-graph 1310 contains sections 1 and 3 (1110 and 1130) as well as pipe 2 and sub-pipe 3.3 (1220 and 1260)), sub-graph 1320 contains section 2, 4 and 5 (1120, 1140, and 1150) as well as pipe 1 and sub-pipes 3.0 to 3.2 (1210, 1230, 1240, and 1250), and sub-graph 1330 contains sections 6 and 7 (1160 and 1170) as well as pipes 4 to 6 (1270, 1280, and 1290).

The operations performed when executing a neural network can be broken down into a sequence of operations forming a directed graph in the form described in respect of FIG. 1a. Examples herein provide a more efficient use of storage during execution of a directed graph of operations such as that shown in FIG. 1a.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 1a.

FIG. 1b shows schematically an example of a data processing system 600 including a processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing Units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable to utilize some of the GPU's existing resources (e.g. such that at least some functional units and resources of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor means that the machine learning processing circuit may then be operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this disclosure. These tasks may be self-contained operations, such as a given machine learning operation or a graphics processing operation. It will be appreciated that there may be other types of tasks depending on the command.

The task data 620 is sent by the host processor 610 and is received by a command processing unit 640 which is arranged to schedule the commands within the task data 620 in accordance with their sequence. The command processing unit 640 is arranged to schedule the commands and decompose each command in the task data 620 into at least one task. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second tasks may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access to data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher-level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBA®) interface, such as the Advanced extensible Interface (AXI), may be used.

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a progression of operations representing a sequence of layers of the neural network. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 732, a vector engine 734, a transform unit 738, an accumulator buffer 736, and a shared storage 730, for processing of blocks of data. The data dependencies across the functional units are tracked by the handling unit 720. Processing is initiated by the handling unit 720 in a functional unit if all input blocks are available and space is available in the shared storage 730 of the neural engine 700. The shared storage 730 may be considered to be a shared buffer, in that various functional units of the neural engine 700 share access to the shared storage 730.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. For example, the weight fetch unit 722, input reader 724, output writer 726, dot product unit array 732, vector engine 734, transform unit 738 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The handling unit 720 is configured to allocate storage elements to respective connections in the directed graph, which can correspond to pipes or sub-pipes as explained above. For example, portions of the accumulator buffer 736 and/or portions of the shared storage 730 can each be regarded as a storage element that can act to store data for a pipe or a sub-pipe within the directed graph, as allocated by the handling unit 720. A pipe or a sub-pipe can act as a connection between sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe or a sub-pipe.

The weight fetch unit 722 fetches weights associated with the neural network from external storage and stores the weights in the shared storage 730. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 732, vector engine 734 and transform unit 738 to generate output data corresponding to an operation in the directed graph. The result of each operation is stored in a specific pipe or sub-pipe within the neural engine 700. The DPU array 732 is arranged to perform one or more operations associated with a dot product operation between two operands, such as between an array of weights and a corresponding block of data (e.g. representing part of a tensor). The vector engine 734 is arranged to perform elementwise operations, for example to apply scale parameters to scale an output of a dot product calculated by the DPU array 732. Data generated during the course of the processing performed by the DPU array 732 and the vector engine 734 may be transmitted for temporary storage in the accumulator buffer 736 from where it may be retrieved by either the DPU array 732 or the vector engine 734 (or another different execution unit) for further processing as desired.

The transform unit 738 is arranged to perform in-block transforms such as dimension broadcasts or axis swaps. The transform unit 738 obtains data (e.g. after processing by the DPU array 732 and/or vector engine 734) from a pipe or a sub-pipe, for example mapped to at least a portion of the shared storage 730 by the handling unit 720. The transform unit 738 writes transformed data back to the shared storage 730.

To make efficient use of the shared storage 730 available within the neural engine 700, the handling unit 720 determines an available portion of the shared storage 730, which is available during execution of part of a first task (e.g. during processing of a block of data associated with the first task by the DPU array 732, vector engine 734 and/or transform unit 738). The handling unit 720 determines a mapping between at least one logical address associated with data generated during execution of a second task (e.g. by processing of a block of data associated with the second task by the DPU array 732, vector engine 734 and/or transform unit 738) and at least one physical address of the shared storage 730 corresponding to the available portion. The logical address is for example a global address in a global coordinate system. Hence, by altering the physical address corresponding to a given logical address, the handling unit 720 can effectively control usage of the shared storage 730 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

In an analogous manner, the handling unit 720 can determine a mapping between logical storage locations (e.g. corresponding to respective logical addresses) corresponding to respective connections within the directed graph and sets of storage elements (e.g. corresponding to sets of physical addresses within storage of the neural engine 700, such as within the accumulator buffer 736 and/or the shared storage 730). In this way, the handling unit 720 can dynamically allocate first and second sets of storage elements to correspond to first and second logical storage locations associated with first and second operations (e.g. first and second sections) of the directed graph.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements and/or between sub-pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes and/or sub-pipes.

All storage in the neural engine 700 may be mapped to corresponding pipes and/or sub-pipes, including look-up tables, accumulators, etc., as discussed further below. The width and height of pipes and/or sub-pipes can be programmable, resulting a highly configurable mapping between pipes, sub-pipes and storage elements within the neural engine 700.

Ordering of execution of the sections is implied by dependencies on inputs. A memory load operation has no data dependencies (unless it is a gather operation), so is implicitly early in the graph. The consumer of the pipe (or sub-pipe) that the memory read produces is implicitly after the memory read. A memory store operation is near the end of the graph, as it produces no pipes or sub-pipes for other operations to consume. The sequence of execution of a progression of operations is therefore handled by the handling unit 720 as will be explained in more detail later.

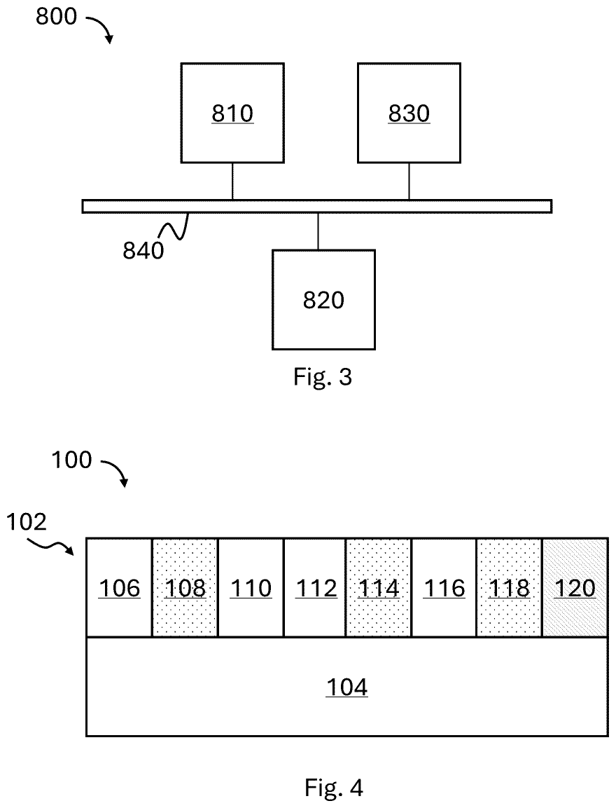

FIG. 3 shows schematically a system 800 for allocating handling data, and in some examples generating a plurality of blocks of input data for processing.

The system 800 comprises host processor 810 such as a central processing unit, or any other type of general processing unit. The host processor 810 issues task data comprising a plurality of commands, each having a plurality of tasks associated therewith.

The system 800 also comprises a processor 830, which may be similar to or the same as the processor 630 of FIG. 1b and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBAR) interface, such as the Advanced extensible Interface (AXI), may be used.

### Neural Engine Program Descriptor (NED)

As explained above, the neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issued by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes and/or sub-pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes and/or sub-pipes. In one implementation, each of the execution units and each storage element (or portion of a storage element) of the neural engine 700 has a sub-descriptor definition which defines how that execution unit/storage element can be configured for use in implementing a specific section, pipe or sub-pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes and/or sub-pipes. Pipes and/or sub-pipes are used to represent data storage elements within the neural engine 700 and describe the relationship between sections (operations) in a producer-consumer relationship: the output destination pipe or sub-pipe (e.g. a pipe or sub-pipe number) and each input source pipe or sub-pipe (e.g. a pipe or sub-pipe number) for every section is defined in the NED elements of the NED. Pipes and sub-pipes each have only a single producer but may have multiple consumers. A pipe and/or a sub-pipe may be mapped to one of several different physical storage locations (e.g. storage units in the neural engine 700), but not all physical storage locations may be suitable for the different section operations. It will be appreciated that, in some arrangements, a pipe and/or a sub-pipe may be mapped to only a portion of a storage unit, which may include at least one storage element. For example, a physical buffer (or a set of physical buffers, which may be or form part of a memory bank) may be considered to be a storage unit, and a physical address (or a set of physical addresses) corresponding to or within a physical buffer may be considered to be a storage element. For example, a storage unit may correspond to a set of physical buffers and a storage element may be a physical buffer of the set of physical buffers, the physical buffer comprising a set of physical addresses. In such cases, a pipe and/or a sub-pipe can describe double-buffering (for example) behavior between its producer and consumers. The output data generated by a section and stored in a pipe or a sub-pipe is referred to equivalently as both a block (of data) and a (virtual) buffer, with a block of data occupying one physical buffer location. Irrespective of location, pipes and/or sub-pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input. In examples, though, the NED may be configured such that each sub-pipe has a single producer.

In some embodiments, sections such as InputReader and WeightFetcher have no input pipes or sub-pipes and instead their data comes from external memory, such as an external cache or DRAM. By contrast, some sections, such as OutputWriter have no output pipes or sub-pipes. In this case, their data is written to external memory.

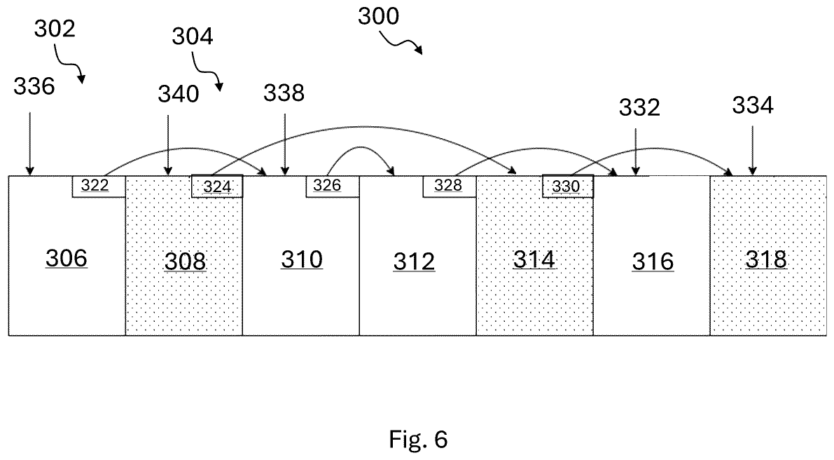

For a section to run, it must have all the appropriate buffers available for its input source pipes and/or sub-pipes. A section may produce a new buffer in its output destination pipe or sub-pipe and so there must be space available in the pipe or sub-pipe for this new buffer. The neural engine 700 is responsible for tracking all of these dependencies as discussed further below with reference to FIG. 6.

The NED also contains information that describes any divergent or convergent branches between sections and pipes/sub-pipes. For example the NED identifies, for each pipe and sub-pipe in the graph, the number of producers and consumers associated with respective pipes and sub-pipes. The NED may also comprise pointers to each of the sub-descriptor elements to enable the specific configuration of each element to be read by the handling unit 720.

### Dynamic Storage Allocation

Dynamic allocation of respective storage elements to different sub-pipes by the handling unit 720 will now be described in more detail, with reference to FIGS. 4 to 8.

FIG. 4 illustrates schematically storage 100 comprising two storage units 102, 104 each corresponding to a respective set of buffers, according to a simplified example. Each storage unit 102, 104 comprises eight buffers, each corresponding to a different respective storage element. Each of the storage elements corresponds to a different respective physical location within the storage unit 102, 104. The eight storage elements are labelled with reference numerals 106-120 for the first storage unit 102 and omitted for the second storage unit 104, for clarity. The storage 100 of FIG. 4 may be used as storage of or accessible to the neural engine 700 of FIG. 2, such as the accumulator buffer 736 or the shared storage 730 (which may be referred to herein as a shared buffer). It is to be appreciated that the example of FIG. 4 is merely illustrative and in other cases a storage may include more or fewer storage units than two, a storage unit may be a different physical area of a storage than a set of buffers, a storage element may be a different component of a storage unit than a buffer and/or a storage unit may include more or fewer storage elements than eight.

In an example in which the storage 100 is used as the accumulator buffer 736, the storage 100 may be a high bandwidth SRAM static random access memory, which may be used to pass data between the convolution engine and the vector engine. The storage 100 may be partitioned such that portions of the convolution engine selectively communicate with specific banks of the storage 100, respectively. This may reduce data routing and simplify the physical structure of the storage 100. The accumulator buffer 736 in this example is smaller than the shared storage 730 and therefore consumes less power per access than the shared storage 730. In a particular example, the accumulator buffer 736 comprises two buffers of 16K 32-bit accumulators each, such as two of the buffers 106-120 shown in the illustrative example of FIG. 4.

In examples, a directed graph represented by task data may include a plurality of convolution engine sections in a chain. To accommodate this, the accumulator buffer 736 could be increased relative to a size for accommodating a single convolution engine section. However, this would increase the physical area of the hardware occupied by the accumulator buffer 736 and increase the power consumption for accessing data within the accumulator buffer 736. Hence, in examples herein, different sets of storage elements of a given storage unit (the first storage unit 102 in FIG. 4) are dynamically allocated to correspond to different logical storage locations, corresponding to different sub-pipes, for storing respective outputs of different operations, corresponding to different sections. This allows multiple sections to write to the same physical storage (in this case, to the same storage unit 102). Each sub-pipe (corresponding to a respective set of storage elements) in these examples has a single producer and at least one consumer (where the producer and at least one consumer are respective sections of the directed graph). Sub-pipes may thus be used to pass data between respective sections, but with a plurality of sections sharing the same underlying physical storage unit 102.

The first storage unit 102 in this case, comprising the storage elements 106-120 which are dynamically allocated to different sub-pipes, may be considered to correspond to a multi-pipe. In examples, a multi-pipe is mapped by the handling unit 720 to a unique physical storage location, which in this case is a unique storage unit 102. The physical storage location of a given multi-pipe does not overlap with the physical storage location of other multi-pipes (such as any other multi-pipe). However, a plurality of sub-pipes can be mapped to the same multi-pipe by the handling unit 720. The handling unit 720 can manage the mapping of the plurality of sub-pipes to the same physical storage location (the first storage unit 102 of FIG. 4), by managing the status of each of the sub-pipes in a given multi-pipe to avoid data being incorrectly overwritten and so forth.

To simplify execution of the task, various properties of sub-pipes may be the same for all sub-pipes of a given multi-pipe, such as a number of storage elements (and/or storage units) for a given sub-pipe, a storage unit and/or storage comprising the storage elements (such as whether the storage elements are within the accumulation buffer 736 or the shared storage 730), a start memory bank at which a given storage unit associated with the multi-pipe starts, a number of memory banks for the given storage unit, a start memory word for the given storage unit, a number of memory words for the given storage unit, and so on. However, at least one property may differ between sub-pipes of a multi-pipe, such as data specific parameters, e.g. the data values to be written to a given sub-pipe, a format of the data values, whether the data values are signed values and so forth.

The mapping of a plurality of sub-pipes to the same multi-pipe may be indicated by the task data. For example, the task data may indicate that the first and second logical storage locations (associated with first and second operations of the directed graph) are each associated with a logical storage area. The handling unit 720 can then allocate a particular physical region of the storage 100, such as the first storage unit 102, to correspond to the logical storage area, based on the task data.

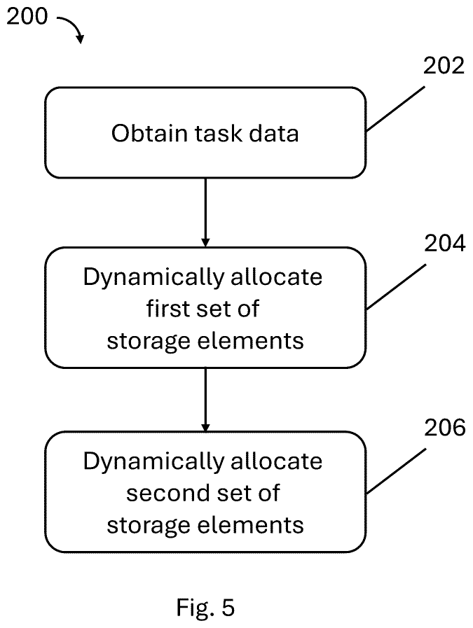

FIG. 5 is a flow diagram illustrating a method 200 of handling data in a processor, which may be used to dynamically allocate the storage 100 of FIG. 4. At item 202 of the method 200, task data is obtained, which describes a task to be executed, comprising operations representable as a directed graph comprising operations connected by connections. As in examples above, a first connection is associated with a first output of a first operation and corresponds to a first logical storage location, and a second connection is associated with a second output of a second operation and corresponds to a second logical storage location. It is to be appreciated that the terms “first” and “second” in this context are not intended to imply a temporal order to these features and instead are merely used to distinguish between two instances of the same feature, which may exist or be performed at least partly concurrently.

As explained above, an extra field may be added to naming of a multi-pipe, as indicated by the task data (e.g. in the form of a NED) to indicate the sub-pipe. For simplicity, each pipe of a directed graph may be considered to be a multi-pipe even though some of the so-called multi-pipes may only have a single sub-pipe. For example, an identifier in the form of PX.Y (where “P0” indicates the multi-pipe and “Y” indicates the sub-pipe) may be used to uniquely identify multi-pipes (and sub-pipes of respective multi-pipes). For example, a section A may write to P0.0 and a section B may write to P0.1 (i.e. sections A and B may write to sub-pipes 0 and 1 of multi-pipe 0).

In examples, the operations of the directed graph representable by the task data comprise at least one consumption operation involving at least partial reading of a sub-pipe. In such cases, the task data indicates the sub-pipe each of the at least one consumption operation is configured to read data from.

At item 204 of the method 200, a first set of storage elements (such as a first set of the storage elements 106-120 of the first storage unit 102 of FIG. 4) are dynamically allocated to correspond to the first logical storage location. At item 206 of the method 200, a second set of storage elements (such as a second set of the storage elements 106-120 of the first storage unit 102 of FIG. 4) are dynamically allocated to correspond to the second logical storage location. As used herein, a set of components may be considered to refer to at least one of the components. Although items 204 and 206 are shown as separate items of the method 200, they may be performed at least partly concurrently (and in some cases may be performed entirely concurrently, such as in a single allocation operation). The dynamic allocation may be performed by a processor to implement the first and second operations, but need not necessarily be performed by the same component of the processor as that used to implement the first and/or section operations. In examples in which the processor comprises the neural engine 700 of FIG. 2, the dynamic allocation may be performed by the handling unit 720.

The first and second set of storage elements are dynamically allocated, meaning that the storage element(s) allocated to the first and/or second set may vary over time. For example, respective storage elements 106-120 of the first storage unit 102 may be successively allocated to the first or second set of storage elements as the first and/or second operations are executed and portions of the first and/or second outputs are generated and are to be written to the storage 100.

The first and second set of storage elements may be dynamically allocated such that, at a given time, the first set is disjoint from the second set, so that respective storage elements 106-120 of the first storage unit 102 are allocated to either the first set or the second set (or neither) at the given time. This allows the first and second operations to be executed at least partly concurrently without risking overwriting the data written to the first and second sub-pipes (corresponding to the first and second sets respectively). For example, the handling unit 720 may dynamically schedule the first and second operations for execution by execution circuitry (e.g. to implement an execution unit described above, such as the convolution engine or the vector engine) such that at least part of the first output is written to the first set during writing of at least part of the second output to the second set.

Dynamically allocating the first and second sets of storage elements in this way may mean that consecutive storage elements of a given set are not located contiguously with each other within the storage 100. Storage elements of a first set may thus be interleaved with storage elements of a second set and vice versa. For example, at least one storage element of the second set may be disposed between a first storage element of the first set and a second storage element of the first set within the storage unit, such as the first storage unit 102 of FIG. 4. FIG. 4 shows such an example.

In FIG. 4, the first, third, fourth and sixth storage elements 106, 110, 112, 116 are successively allocated to a first set (shown without shading in FIG. 4). The second, fifth and seventh storage elements 108, 114, 118 are allocated to a second set (shown with dotted shading in FIG. 4). The eighth storage element 120 is unallocated and is shown with diagonal shading in FIG. 4. FIG. 4 therefore illustrates an example of non-contiguous first and second sets, with the second storage element 108 (of the second set) interleaved between the first and third storage elements 106, 110 (of the first set), and the sixth storage element 116 (of the first set) interleaved between the fifth and seventh storage elements 114, 118 (of the second set).

As at least one of the first and second sets of storage elements for storing the first and second outputs, respectively, may include non-contiguous storage elements within the storage 100, it may not be sufficient to merely track the head and tail of the first and second sets in order to determine which storage elements are allocated to the first and second sets respectively. Hence, in examples herein, the handling unit 720 is configured to track usage of the storage elements 106-120 during execution of the task, and to dynamically allocate the first and second sets at least partly based on the usage tracked by the handling unit 720. For example, the handling unit 720 may track the usage to identify which storage elements are available for allocation to the first set or the second set, and then allocate an available storage element to the first set or the second set. The handling unit 720 may determine which of a plurality of available storage elements to allocate to a given set based on at least one further rule, for example to optimize usage of the storage 100, e.g. such that the storage elements allocated to a particular set are more compactly distributed within the storage 100 than otherwise.

FIG. 6 shows an example of tracking of the usage of the storage elements 106-120 of FIG. 4, in which at least one data structure 300 is used to track allocation of the storage elements 106-120 to the first and second sets of storage elements. In the example of FIG. 6, the at least one data structure 300 comprises a first linked list 302 and a second linked list 304. The first linked list 302 is used to track allocation of storage elements to the first set and the second linked list 304 is used to track allocation of storage elements to the second set. The first linked list 302 includes entries 306, 310, 312, 316 corresponding to the storage elements 106, 110, 112, 116 of the first set, and the second linked list 304 includes entries 308, 314, 318 corresponding to the storage elements 108, 114, 118 of the second set. The entries 306, 310, 312, 316 of the first linked list 302 are shown unshaded and the entries 308, 314, 318 of the second linked list 304 are shown with dotted shading in FIG. 6.

The first and second linked lists 302, 304 are generated and populated by the handling unit 720 progressively, as the first and second operations are scheduled dynamically by the handling unit 720. The handling unit 720 dynamically schedules the first operation to sequentially write portions of the first output to respective storage elements of the first set in a first order, at least partly based on the usage tracked by the handling unit 720. The first order may be determined dynamically by the handling unit 720 based on which storage elements of the storage 100 are available as respective portions of the first output are generated. The first order may thus be generated progressively and added to over time with the generation of additional portions of the first order.

In the example of FIGS. 4 and 6, the handling unit 720 determines from the task data that the task comprises the first and second operations, which are to be executed by the neural engine 700, and that the first and second outputs of the first and second operations are to be written to different sub-pipes of the same pipe. Based on the task data, the handling unit 720 allocates the storage unit 102 of the storage 100 to correspond to the pipe, and then dynamically allocates respective storage elements of the storage unit 102 to first and second sub-pipes over time.

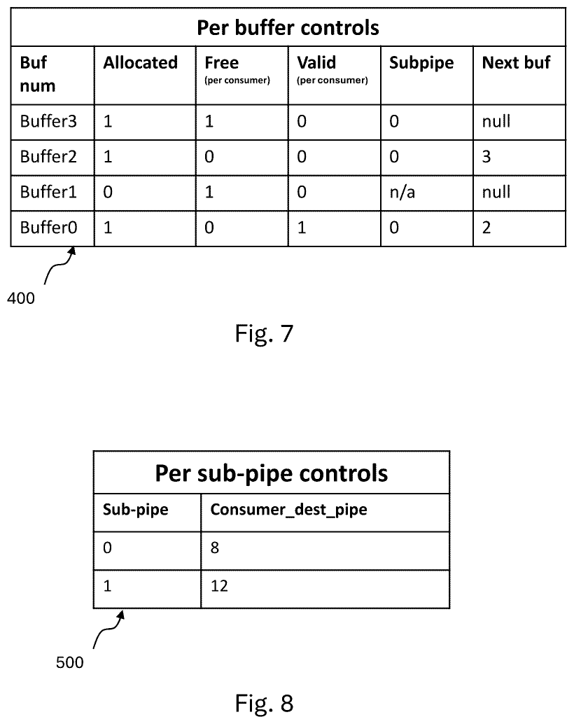

The handling unit 720 tracks usage of the storage unit 102 over time and in this example generates various control data on a per buffer basis (i.e. for each storage element of the storage unit 102) and a per sub-pipe basis. The per buffer control data may be referred to herein as storage element characteristic data for a given storage element, and the per sub-pipe control data may be referred to herein as operation characteristic data. FIGS. 7 and 8 show examples of per buffer controls and per sub-pipe controls for a different example to that of FIG. 6, with a smaller number of buffers for ease of illustration, although it is to be appreciated that similar control data to that shown in FIGS. 7 and 8 may also be obtained in the example of FIG. 6.

FIG. 7 is a table 400 of per buffer controls, and includes an “Allocated” field indicative of whether a given storage element (which in FIG. 7 is a buffer, numbered from Buffer0 to Buffer3) is allocated to a particular sub-pipe. The “Allocated” field therefore indicates whether the given storage element is allocated to a logical storage location as indicated by the task data, such as the first or second logical storage location corresponding to the first or second sub-pipe, respectively. In FIG. 7, the “Allocated” field is a bit for each storage element, which takes a value of 0 if the given storage element is unallocated to a sub-pipe and a value of 1 if the given storage element is allocated to a sub-pipe. The table 400 of FIG. 7 shows that Buffer0, Buffer2 and Buffer3 are allocated, and Buffer1 is unallocated.

The table 400 of FIG. 7 also includes a “Subpipe” field indicative of the sub-pipe to which a given buffer is allocated. The “Subpipe” field thus indicates which logical storage location a given storage element is allocated to, and for example is a unique identifier of the sub-pipe. In FIG. 7, the table 400 indicates that Buffer0, Buffer2 and Buffer3 are allocated to sub-pipe 0, and Buffer1 is unallocated to a sub-pipe and thus does not have an identifier associated with the sub-pipe field for that buffer.

The table 400 of FIG. 7 includes a “Free” field (per consumer), which is a bit per consumption operation indicating whether the given storage element is available for data to be written thereto by a production operation. The task data for example indicates that, for a given sub-pipe, there is a production operation (production section) that produces the sub-pipe and at least one consumption operation (consumption section), corresponding to a consumer, that reads from the sub-pipe. Hence, the consumer(s) of a given sub-pipe, for which the free value is to be determined, can be determined by the handling unit 720 from the task data. In the example of FIG. 7, there is a single consumer. The “Free” field takes a value of 0 for Buffer0 and Buffer2 in table 400 of FIG. 7 and the “Free” field takes a value of 1 for Buffer1 and Buffer3. It is to be appreciated that when a given buffer is unallocated to a sub-pipe (in this case, with an “Allocated” field having a value of 0), the “Free” field has no meaning. As Buffer1 is unallocated, Buffer1 cannot be written to or read from unless it is first allocated to a sub-pipe, despite the “Free” field having a value of 1. However, as Buffer3 is allocated to sub-pipe 0 and is free, it can be written to by a producer of sub-pipe 0.

The table 400 of FIG. 7 also includes a “Valid” field (per consumer), which is a bit per consumption operation indicating whether the given storage element is storing valid data to be read therefrom (by the consumption operation). The table 400 of FIG. 7 indicates that Buffer0 is storing valid data (with the valid field taking a value of 1) and Buffer1, Buffer2 and Buffer3 are not storing valid data (with the valid field taking a value of 0) for the consumer. As for the “Free” field, the value of the “Valid” field for a given buffer has no meaning unless that buffer is allocated to a sub-pipe (in this case, with an “Allocated” field having a value of 1).

In addition, the table 400 of FIG. 7 indicates the next buffer location for a sub-pipe (indicated by the field “Next buf” in the table). The next buffer location is a unique identifier of a physical storage location of a next storage element within a set of storage elements corresponding to a sub-pipe in this example. In other examples, though, the next buffer location may identify the location of the next storage element in a different manner, such as by a physical address of the next storage element. The table 400 of FIG. 7 indicates that the next buffer after Buffer0 is Buffer2, and the next buffer after Buffer2 is Buffer3, and there is no next buffer for Buffer1 and Buffer3. Hence, sub-pipe 0 is formed of Buffer0, then Buffer2, then Buffer3.

FIG. 7 indicates the next buffer location in the form of entries associated with a particular field of the table 400. It is to be appreciated that the next buffer locations shown in the table 400 may be stored in a data structure such as the table 400 and/or may be determined from, or otherwise represented by, at least one data structure used to track an order in which data is written to respective storage elements of a set of storage elements (corresponding to a sub-pipe), such as the first and second linked lists 302, 304 of FIG. 6 without separately storing data representative of the next buffer location in a table such as the table 400 of FIG. 7 (or other data structure). For example, the at least one data structure 300 may include at least a portion of control data such as that shown in FIG. 7. In general, although FIGS. 7 and 8 show control data in the form of a table, the control data (or a portion thereof) need not be stored in a table and may instead be stored in a different format. For example, the control data may merely be a collection of bits each representing a control value for a given buffer and/or sub-pipe, which may be stored in various different data structures, including a linked list (as discussed further below with reference to FIG. 6).

Viewing the table 400 of FIG. 7 as a whole, the table 400 indicates that: Buffer0 is allocated to sub-pipe 0, a production operation to generate data for storage in Buffer0 is complete and the data stored in Buffer0 is ready to be consumed by a consumption operation; Buffer1 is unused; Buffer2 is allocated to sub-pipe 0, a production operation has been issued to store data in Buffer2 and a final reduction sub-operation of the production operation has been issued but is not yet complete; Buffer3 is allocated to sub-pipe 0, a production operation has been issued to store data in Buffer3 but a final reduction sub-operation of the production operation has not yet been issued; and sub-pipe 1 is empty.

FIG. 8 is a table 500 of per sub-pipe controls, and provides an example of operation characteristic data. In examples, operation characteristic data representative of sub-pipe controls such as those shown in FIG. 8 may be stored in a separate data structure for each multi-pipe. The data structure used to store the operation characteristic data may be a table, such as the table 500 of FIG. 8. The data structure for storing the operation characteristic data may be separate and distinct from a data structure used for storing storage element characteristic data.

The table 500 of FIG. 8 includes a “Sub-pipe” field indicative of respective sub-pipes of a given pipe, which in this case are sub-pipes 0 and 1. The table 500 of FIG. 8 also includes a “Consumer_dest_pipe” field, which indicates a destination storage pipe for storing an output of a consumer of the corresponding sub-pipe. The “Consumer_dest_pipe” may be considered to indicate a logical destination storage area for storing a further output to be generated during execution of a first consumption operation of the plurality of operations comprising at least partial reading of input data stored in the corresponding sub-pipe (such as the first output of the first operation, stored in the first sub-pipe). The table 500 of FIG. 8 indicates that the consumer of sub-pipe 0 has a destination pipe with an identifier of 8, and the consumer of sub-pipe 1 has a destination pipe with an identifier of 12. The destination pipe may be mapped to a destination storage unit by the handling unit 720.

Although not shown in FIG. 8, it is to be appreciated that operation characteristic data (which may be generated on a per sub-pipe basis) may indicate at least one further characteristic of an operation of the directed graph. For example, the operation characteristic data may indicate an availability of the logical destination storage area (where the logical location of the logical destination storage area may be indicated by the “Consumer_dest_pipe” field of FIG. 8). This availability may be indicated in a table otherwise similar to the table 500 of FIG. 8 as a “Consumer_dest_free” field, providing an indicator of whether the logical destination storage area is free or not, e.g. using a bit which takes a value of 0 if the logical destination storage area is not free and a value 1 if the logical destination storage area is free. The handling unit 720 may handle the underlying mapping between the logical destination storage area and a (physical) destination storage unit to ensure that the availability of the underlying physical storage unit corresponding to the logical destination storage area is correctly reflected in the value of the “Consumer_dest_free” field for a given sub-pipe.

The operation characteristic data may additionally or alternatively indicate the next buffer to be consumed by a given consumer (corresponding to a given consumption operation of the directed graph), on a per-consumer, per sub-pipe basis and/or the last buffer allocated to a sub-pipe on a per sub-pipe basis. These values may be determined based on or otherwise represented by the at least one data structure 300 and/or may be used to update the at least one data structure 300. For example, a “Last allocated” field indicative of the last buffer allocated to a given sub-pipe may be used to update a linked list such as the first or second linked list 302, 304.

Returning to FIGS. 4 and 6, the usage of the storage elements 106-120 tracked by the handling unit 720 may be used by the handling unit 720 to assist in scheduling operations of the directed graph, such as operations corresponding to sections that produce or consume a sub-pipe corresponding to at least one of the storage elements 106-120. For example, the handling unit 720 may instruct execution of the first operation (to produce the first output) in response to determining that a logical source storage area for storing the source data to be processed during execution of the first operation comprises valid source data, the storage unit comprises an available storage element of the plurality of storage elements available for storage of data therein (where the available storage element may be available for allocation to the first set of storage elements, or already allocated to the first set) and/or a logical destination storage area is available for storing a further output to be generated during execution of a first consumption operation of the plurality of operations comprising at least partial reading of the first output. The handling unit 720 may map the logical source storage area and/or the logical destination storage area to respective storage units (or other physical storage areas) of the storage prior to or after determining to instruct the execution of the first operation.

The handling unit 720 may dynamically schedule, for execution by the execution circuitry (such as a component of the neural engine 700), a first consumption operation comprising at least partial reading of the first output and a second consumption operation comprising at least partial reading of the second output. The handling unit 720 may thus schedule execution of the task so that there are different consumers of data stored within the same pipe (in this case, corresponding to the storage unit 102) but within different sub-pipes (in this case, within different sets of storage elements 106-120). However, scheduling of respective operations of the handling unit 720 may be performed to avoid conflicts between operations, such as deadlock.

Deadlock could occur when a section that writes to one sub-pipe is also a consumer of data created by another section that writes to a different sub-pipe in the same multi-pipe. The consumer may be a direct consumer of the sub-pipe or a consumer downstream in the sub-graph. For example, deadlock could occur if the first operation that writes to the first set of storage elements corresponding to the first sub-pipe is also a consumer of at least a portion of the second output generated by the second operation that writes to the second set of storage elements corresponding to the second sub-pipe (which is in the same multi-pipe as the first sub-pipe).

For example, if there were two matrix multiplication (MatMul) operations (sections) that write to different sub-pipes in the same accumulator buffer 736 pipe as follows:
Section 0: MatMul K*Q->KQ, stored in P0.0 (sub-pipe 0 of multi-pipe 0, in the accumulator buffer 736, which in this example has 2 buffers)
Section 1: VE operation KQ->KQ′, stored in P1 (pipe 1, in the shared storage 730, which in this example has 2 buffers)
Section 2: MatMul KQ′*V->KQ′V stored in P0.1 (sub-pipe 1 of multi-pipe 0, in the accumulator buffer 736)
Section 3: VE operation to move KQ′V from the accumulator buffer 736->KQ′V to P2 (pipe 2, in the shared storage 730)
   where K*, K, Q, Q′. Q′* represent different respective data values to be processed together as set out above.

Considering the case in which Section 0 must be issued (for example, executed) 4 times before Section 2 can be issued for the first time. For this to occur, Section 1 would have to be issued twice to empty P0 and fill the 2 buffers in P1. However, at this point, the two buffers in P1 would be full and the two buffers in P0 would also be full. Now Section 2 cannot be issued because P0 is full and P1 cannot be drained because Section 2 cannot be issued, meaning that the operations are in deadlock.

To assist in avoiding this, the handling unit 720 may apply various rules, which may be based on control data as described above, such as the storage element characteristic data and/or the operation characteristic data. For example, the handling unit 720 may schedule execution of at least part of the task so that each sub-pipe for that part of the task only has consumers that write to pipes with dedicated storage (so that there are no sub-pipes writing to other sub-pipes). This may make it easier to keep track of usage of the physical storage to reduce the risk of conflicts such as deadlock.

The handling unit 720 may also or instead issue a section that writes to a sub-pipe (such as the first operation or the second operation) in response to determining that both the destination sub-pipe for that section (such as the first sub-pipe or the second sub-pipe) and the consumer destination pipe (or pipes) for each consumer of that section (e.g. corresponding to respective logical destination storage areas discussed above) have at least one free storage element. This may be determined by the tracking of the free status of the destination sub-pipe and the consumer destination pipe by the handling unit 720, e.g. as represented by the “Free” field of the table 400 of FIG. 7 for the destination sub-pipe and the “Consumer_dest_free” field for the consumer destination pipe, as described further above. These fields may be updated at different times. For example, the “Free” field for the destination sub-pipe may be updated upon scheduling of the section that writes to the destination sub-pipe (such as the first operation, if the destination sub-pipe is the first sub-pipe). In contrast, the “Consumer_dest_free” field for the consumer destination pipe may be updated upon scheduling of the consumer section that writes to the consumer destination pipe (such as the first consumption operation), which may be scheduled by the handling unit 720 at a different time to the section that writes to the destination sub-pipe. In view of this, the free status of the consumer destination pipe for the issue of the section writing to the sub-pipe may be tracked by the handling unit 720 separately from tracking of the free status of the consumer destination pipe by the consumer section itself, as these statuses may be updated at different times (at the issue the respective sections).

The handling unit 720 also updates various control data as sections (operations) are issued, to keep track of current usage of the storage. In an example, the first operation successively generates blocks of data values so that the first output of the first operation comprises the blocks. For example, the blocks may correspond to respective portions of a multi-dimensional tensor. The first operation may for example be a reduction operation. The first operation may comprise a plurality of sub-operations, each configured to generate a respective block of the blocks. At least one of the blocks may depend on at least one prior block. For example, an initial block may be generated by an initial sub-operation of the first operation and the blocks may include at least one intermediate block, generated by an intermediate sub-operation of the first operation in dependence on the initial block (either directly or indirectly) and a final block, generated by a final sub-operation of the first operation in dependence on the intermediate block. In this example, the handling unit 720 may successively allocate storage elements of the storage 100 to store a respective block of the first output, so that the first set of storage elements comprises the storage elements allocated to store respective blocks of the first output at a given time. In an example in which the first operation is a reduction operation, the handling unit 720 sets the value of the “Allocated” field to 1 for the storage element of the storage 100 that the handling unit 720 has allocated to store the initial block (which may be referred to as an initial storage element), indicating the initial storage element has been allocated for data storage at that time. In other words, the handling unit 720 updates the value stored in the “Allocated” field for the initial storage element, which is comprised by the first sub-pipe. For the initial storage element, the handling unit 720 also updates the value stored in the “Sub-pipe” field to indicate that the initial storage element belongs to the first sub-pipe (and hence to the first set of storage elements) at that time. It is to be appreciated that the second operation (and any other operation described herein) may similarly generate blocks in a similar manner to the first operation.

The handling unit 720 updates control data such as this over time as respective storage elements of the storage 100 are allocated to store respective blocks generated by the first or second operations. In an example in which the first operation is a reduction operation, the handling unit 720 sets the value of the “Free” field to 0 for the storage element of the storage 100 that the handling unit 720 has allocated to store the final block of the reduction operation (which may be referred to as a final storage element). This indicates that the first operation has finished, and that the final block is ready to be read by a consumption operation comprising at least partial reading of the first output (such as reading of the final block of the first output), which may be referred to herein as a first consumption operation.

When the first consumption operation is issued, if the reading of the final block is not the final reading of the final block for the first consumption operation (e.g. as determined by the handling unit 720 based on the task data), the handling unit 720 may maintain the control data without updating the values represented by the control data (e.g. so that the status bits, such as those of tables 400 and 500 of FIGS. 7 and 8 remain the same). However, if the reading of the final block is the final reading (e.g. as determined by the handling unit 720 based on the task data), the handling unit 720 may update the control data. For example, if this is the case, the handling unit 720 may update the value of the “Valid” field for the final storage element to 0, the value of the “Allocated” field for the final storage element to 0 and the value of the “Free” field for the final storage element to 1. This indicates that the final storage element, at this stage, does not store valid data, is unallocated and is available for storing further data thereto. The handling unit 720 may update the control data in this case after the final reading of the final block has been issued, to maintain the final block in the final storage element until after the final reading is complete. However, the control data may be updated before the handling unit 720 allocates at least one storage element of the storage for storing data generated in a subsequent operation or sub-operation (which may be scheduled to be executed by the execution circuitry immediately subsequent to the final sub-operation, such as consecutively after the final sub-operation), so that the subsequent operation or sub-operation can utilize the final storage element for storing the generated data.

At a time of scheduling the first sub-operation of the first operation, the entire first storage unit 102 is available for storing the first portion of the first output in the example of FIGS. 4 and 6. This is for example indicated by the values of the “Allocated” fields for each of the storage elements 106-120 of the first storage unit 102 being 0. The handling unit 720 determines, for example based on the control data (such as the values of the “Allocated” fields), that each of the storage elements 106-120 is available and allocates a storage element of the storage (in this case, the first storage element 106) for storing the first portion of the first output, which in this example is an initial block of the first output. The handling unit 720 then generates the first linked list 302 of the at least one data structure 300, and populates the first linked list 302 with the first entry 306. The first entry 306 comprises first location data indicative of a physical storage location of the first storage element 106 within the first storage unit 102. For example, the first location data may indicate a physical address of the first storage element 106 within the first storage unit 102. The handling unit 720 sends execution instructions, comprising the first location data of the first entry 306, to an execution unit of the neural engine 700 to instruct the execution unit to execute the first sub-operation of the first operation to generate the initial block of the first output and store the initial block of the first output in the first storage element 106.

The handling unit 720 then schedules a first sub-operation of the second operation to be executed by the neural engine 700, in order to generate data corresponding to a first portion of the second output (for example representing an initial block of the second output). At a time of scheduling the first sub-operation of the second operation, the second to eighth storage elements 108-118 are available for storing the first portion of the second output and the first storage element 106 is occupied by the first portion of the first output. The handling unit 720 determines that second to eighth storage elements 108-120 of the first storage unit 102 are available, for example based on the control data discussed above and/or the first linked list 302, and allocates a storage element of the storage (in this case, the second storage element 108) for storing the initial block of the second output. The handling unit 720 then generates the second linked list 304, and populates the second linked list with the second entry 308. The second entry 308 comprises second location data indicative of a physical storage location of the second storage element within the first storage unit 102. For example, the second location data may be similar to the first location data, and may indicate a physical address of the second storage element 108 within the first storage unit 102. The handling unit 720 sends execution instructions, comprising the second location data of the second entry 308, to an execution unit of the neural engine 700 to instruct the execution unit to execute the first sub-operation of the second operation to generate the initial block of the second output and store the initial block of the second output in the second storage element 108.

The handling unit 720 progressively allocates respective storage elements of the first storage unit 102 to store blocks of the first or second outputs and generates respective location data indicative of a location of each respective storage element, in a similar manner to allocation of the first and second storage elements 106, 108. The handling unit 720 progressively creates new entries of the first or second linked lists 302, 304 as storage elements of the first storage unit 102 are newly allocated to store respective blocks of the first or second outputs. Respective execution instructions are sent to the neural engine 700, comprising respective location data indicative of a location in which respective blocks of the first or second outputs are to be stored, to instruct execution of respective sub-operations of the first or second operations to generate the respective blocks.

In this way, a second entry 310, a third entry 312 and a fourth entry 316 are successively added to the first linked list 302 by the handling unit 720, respectively comprising location data indicative of a location of the third storage element 110, the fourth storage element 112 and the sixth storage element 316 in which successive blocks of the first output (to be generated successively after the initial block of the first output) are to be stored. Similarly, a second entry 314 and a third entry 318 are successively added to the second linked list 304 by the handling unit 720, respectively comprising location data indicative of a location of the fifth storage element 114 and the seventh storage element 118 in which successive blocks of the second output (to be generated successively after the initial block of the second output) are to be stored.

The first linked list 302 may be considered order data that is indicative of a first order in which the respective portions of the first output (in this case, corresponding to respective blocks of the first output) are written to the respective storage elements of the first set. In other words, the first order in this case is represented as the first linked list 302. The second linked list may similarly be considered order data indicative of a second order in which respective blocks of the second output are written to the respective storage elements of the second set.

In FIG. 6, the first linked list 302 comprises pointers 322, 326, 328 for respective storage elements of the first set such that a given pointer for a given storage element of the first set points to a location of a successive storage element of the first set, to be written to successively after the given storage element, according to the first order. A given pointer for a particular entry of the first linked list 302 for example points to a successive entry of the first linked list 302, which comprises successive location data indicative of a physical storage location of the successive storage element to be written to successively after the storage element associated with the given pointer. The given pointer thus points to the location data for the successive storage element by pointing to the successive entry within the first linked list 302 (comprising the location data for the successive storage element). For example, the first entry 306 of the first linked list 302 comprises first location data indicative of a physical storage location of the first storage element 106, as well as a first pointer 322 to the second entry 310 of the first linked list 302, which comprises successive location data indicative of a physical storage location of a successive storage element to be written to successively (e.g. consecutively) after the first storage element 106 in executing the first operation. In this case, the successive location data of the second entry 310 of the first linked list 302 is indicative of the physical storage location of the third storage element 110 of the first storage unit 102. Similarly, the second entry 310 of the first linked list 302 comprises a pointer 326 to a third entry 312 of the first linked list 302. The third entry 312 of the first linked list 302 comprises a pointer 328 to a fourth entry 316 of the first linked list 302. The fourth entry 316 of the first linked list 302 is the final entry of the first linked list 302 at the time illustrated in FIG. 6 and thus does not comprise a pointer to a subsequent entry.

The second linked list 304 also comprises pointers 324, 330 for respective storage elements of the second set such that a given pointer for a given storage element of the second set points to a location of a successive storage element of the second set, to be written to successively after the given storage element, according to the second order. In FIG. 6, the first entry 308 of the second linked list 304 comprises a pointer 324 to the second entry 314 of the second linked list 304, and the second entry 314 of the second linked list 304 comprises a pointer 330 to the third entry 318 of the second linked list 304. The third entry 318 of the second linked list 304 is the final entry of the of the second linked list 304 at the time illustrated in FIG. 6 and thus does not comprise a pointer to a subsequent entry.

To track usage of the storage elements 106-120, the handling unit 720 may track a head of a linked list associated with a set of storage elements allocated for storage of at least part of an output of a given operation. A head of a linked list is for example a most recently generated entry of the linked list, which may be considered to be an initial node of the linked list, via which the linked list is initially accessed. In FIG. 6, the handling unit 720 tracks a head 332 of the first linked list 302 and a head 334 of the second linked list 304. By tracking the head of a linked list associated with a particular sub-pipe, the handling unit 720 can update the pointer in the head when allocating a new storage element for that sub-pipe.

The handling unit 720 may also or alternatively track a tail of a linked list associated with a set of storage elements allocated for storage of at least part of an output of a given operation. A tail of a linked list is for example a least recently generated entry of the linked list, which may be considered to be a final node of the linked list, corresponding to the end of the linked list. The handling unit 620 may track the tail of a linked list for a given sub-pipe on a per-consumption-operation basis so as to determine when a particular storage element can be freed, for example by setting the value of the “Free” field to 1. For example, a particular storage element can be freed once it has been consumed by all of the consumption operations configured to consume that particular storage element.

The handling unit 720 may be configured to schedule at least partial reading of the first output (such as reading of at least one of the blocks of the first output) by at least one consumption operation of the plurality of operations. In such cases, the handling unit 720 can track a tail of the first linked list 302 for each of the at least one consumption operation. In the example of FIG. 6, there are two consumption operations involving at least partial reading of the first output, and a single consumption operation involving at least partial reading of the second output. The first linked list 302 therefore has a first tail 336 associated with the first consumption operation and a second tail 338 associated with the second consumption operation. The first tail 336 of the first linked list 302 corresponds to the first entry 306 of the first linked list 302, indicating that the least recently generated block of the first output being read by the first consumption operation is stored in the first storage element 106. The second tail 338 of the first linked list 302 corresponds to the second entry of the first linked list 302, indicating that the least recently generated block of the first output being read by the second consumption operation is stored in the third storage element 110. The second linked list 304 has a tail 340 associated with the consumption operation of the second output, which corresponds to the first entry 308 of the second linked list 304, indicating that the least recently generated block of the second output being read by the consumption operation is stored in the second storage element 108.

The tails 336, 338, 340 of the first and second linked lists 302, 304 are updated by the handling unit 720 as reading of the first and second outputs by the various consumption operations continue. For example, after the block of the second output stored in the second storage element 108 (which is the initial block of the second output) has been read by the consumption operation, the second linked list 304 is updated by the handling unit 720 so that the tail now corresponds to the second entry 314 of the second linked list 304, indicating that the second entry 314 of the second linked list 304 is now the least recently generated block of the second output being read by the consumption operation.

It is to be appreciated that the entries of a linked list, such as the first and second linked lists 302, 304, may comprise at least a portion of the control data as discussed above. For example, a given entry may comprise at least part of the “Per buffer controls” discussed with reference to FIG. 7, for the storage element corresponding to the given entry. In such cases, as explained above, the handling unit 720 updates the control data stored in the linked list as storage elements are allocated to respective sub-pipes, as data within respective storage elements is consumed by consumption operation(s), and so forth.

The at least one data structure 300 generated by the handling unit 720 allows the physical storage location for different respective portions of data (such as different blocks) of outputs of different operations to be readily identified. This can facilitate re-use of the data before it is overwritten or otherwise removed from the storage. For example, location data within the at least one data structure 300 can be traversed, e.g. by traversing the first and/or second linked lists 302, 304, by the handling unit 720 to identify the physical storage location of a particular storage element storing a block to be processed at a given time, as represented by the location data. In this way, the physical storage location of particular blocks can be identified in a flexible manner so that particular blocks can be re-used as desired (for example, as scheduled by the handling unit 720 to reduce data transfer between various components of the neural engine 700).

### Programs and Systems for Implementing Examples Herein

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

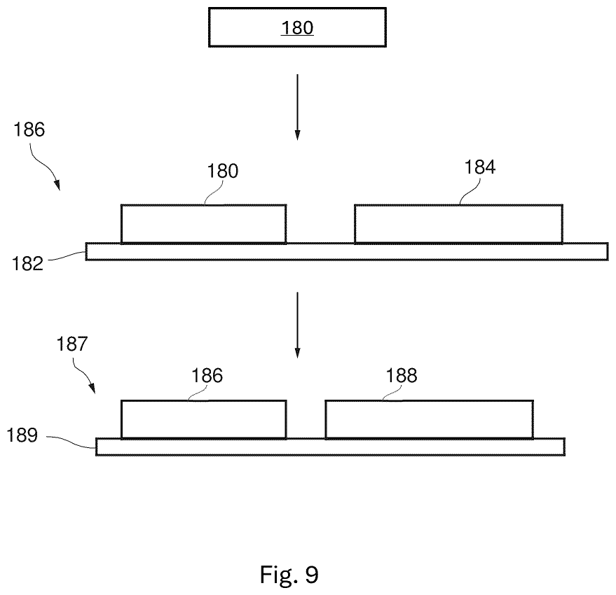

As shown in FIG. 9, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### FURTHER EXAMPLES

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples are envisaged. The example of FIG. 4 is described in the context of the storage 100 corresponding to the accumulator buffer 736. However, in other examples, storage similar to or the same as the storage 100 of FIG. 4, which is dynamically allocated as described herein, may be a different storage or portion of storage of a processor. For example, the storage may be the shared storage 730 described above, for example if the directed graph includes a relatively long chain of operations in which operations at the beginning of the chain complete before operations at the end of the chain begin.

In examples, the handling unit 720 may limit the allocation of sub-pipes to a given multi-pipe such that each multi-pipe has less than or equal to a predefined number of sub-pipes (such as less than 4 sub-pipes, although this is merely an example). The handling unit 720 may also or instead limit the number of consumption operations to consume a particular sub-pipe to a predefined number, such as less than or equal to 4 consumption operations. In such cases, if the directed graph indicates that a particular connection (corresponding to the particular sub-pipe) is connected to more than 4 consumption operations, the handling unit 720 may schedule the consumption operations appropriately so as to limit the number of consumption operations for that sub-pipe to less than or equal to 4 at a given time. These approaches may simplify storage allocation by the handling unit 720.

In examples above, the handling unit 720 performs the dynamic allocation of storage elements to logical storage locations and the scheduling of operations for execution by the neural engine 700. However, in other examples, a different component of a processor than the handling unit 720 may perform at least one of these aspects. For example, at least one of these aspects may be performed by the command and control module 710, alone or in combination with the handling unit 720.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

Further examples are set out in the following numbered clauses:
1. A processor for handling data, the processor comprising a storage unit comprising a plurality of storage elements, the processor configured to:
   obtain task data that describes a task to be executed, the task comprising a plurality of operations representable as a directed graph of operations comprising operations connected by connections corresponding to respective logical storage locations, such that a first connection associated with a first output of a first operation of the plurality of operations corresponds to a first logical storage location and a second connection associated with a second output of a second operation of the plurality of operations corresponds to a second logical storage location; and
   dynamically allocate:
      a first set of the plurality of storage elements of the storage unit to correspond to the first logical storage location; and
      a second set of the plurality of storage elements of the storage unit to correspond to the second logical storage location.
2. The processor of clause 1, wherein the task data is indicative that the first logical storage location is associated with a logical storage area and the second logical storage location is associated with the logical storage area, and the processor is configured to allocate the storage unit to correspond to the logical storage area based at least partly on the task data.
3. The processor of clause 1 or clause 2, wherein the processor is configured to dynamically allocate the first set and the second set such that, at a given time, the first set is disjoint from the second set.
4. The processor of any one of clauses 1 to 3, wherein at least one storage element of the second set is disposed between a first storage element of the first set and a second storage element of the first set within the storage unit.
5. The processor of any one of clauses 1 to 4, wherein the processor comprises execution circuitry and a handling unit, and the handling unit is configured to dynamically schedule the first operation and the second operation for execution by the execution circuitry such that at least part of the first output is written to the first set during writing of at least part of the second output to the second set.
6. The processor of any one of clauses 1 to 5, wherein the processor comprises execution circuitry and a handling unit, and the handling unit is configured to instruct execution of the first operation by the execution circuitry in response to determining that at least one of:
   a logical source storage area for storing source data to be processed during execution of the first operation comprises valid source data for storing source data to be processed during execution of the first operation comprises valid source data;
   the storage unit comprises an available storage element of the plurality of storage elements available for storage of data therein, wherein the available storage element is at least one of: allocated to the first set or available for allocation to the first set; and
   a logical destination storage area is available for storing a further output to be generated during execution of a first consumption operation of the plurality of operations comprising at least partial reading of the first output.
7. The processor of any one of clauses 1 to 6, wherein the processor comprises execution circuitry and a handling unit, and the handling unit is configured to dynamically schedule, for execution by the execution circuitry, a first consumption operation comprising at least partial reading of the first output and a second consumption operation comprising at least partial reading of the second output.
8. The processor of any one of clauses 1 to 7, comprising a handling unit configured to:
   track usage of the plurality of storage elements during execution of the task; and
   dynamically allocate the first set and the second set at least partly based on the usage tracked by the handling unit.
9. The processor of clause 8, wherein the handling unit is configured to:
   dynamically schedule the first operation to sequentially write portions of the first output to respective storage elements of the first set in a first order, at least partly based on the usage tracked by the handling unit; and
   generate order data indicative of the first order.
10. The processor of clause 9, wherein the order data comprises pointers for respective storage elements of the first set such that a given pointer for a given storage element of the first set points to a location of a successive storage element of the first set, to be written to successively after the given storage element, according to the first order.
11. The processor of clause 9 or clause 10, wherein the first order is represented as a linked list.
12. The processor of clause 11, wherein to track the usage of the plurality of storage elements comprises tracking a head of the linked list.
13. The processor of clause 11 or clause 12, wherein the handling unit is configured to schedule at least partial reading of the first output by at least one consumption operation of the plurality of operations and to track the usage of the plurality of storage elements comprises tracking a respective tail of the linked list for each of the at least one consumption operation.
14. The processor of any one of clauses 8 to 13, wherein to track the usage of the plurality of storage elements comprises generating storage element characteristic data for a given storage element of the plurality of storage elements indicating, at a given time, at least one of:
   whether the given storage element is allocated to a logical storage location of a plurality of storage locations comprising the first logical storage location and the second logical storage location;
   the logical storage location to which the given storage element is allocated, if the given storage element is allocated to the logical storage location;
   whether the given storage element is available for data to be written thereto; and
whether the given storage element is storing valid data to be read therefrom.
15. The processor of any one of clauses 8 to 14, wherein to track the usage of the plurality of storage elements comprises generating operation characteristic data indicating, at a given time, at least one of:
   a logical destination storage area for storing a further output to be generated during execution of a first consumption operation of the plurality of operations comprising at least partial reading of the first output; and
   an availability of the logical destination storage area for storing the further output.
16. A system comprising:
   the processor of any one of clauses 1 to 15, implemented in at least one packaged chip;
   at least one system component; and
   a board,
   wherein the at least one packaged chip and the at least one system component are assembled on the board.
17. A chip-containing product comprising the system of clause 16, wherein the system is assembled on a further board with at least one other product component.
18. A non-transitory computer-readable medium having stored thereon computer-readable code for fabrication of the processor of any one of clauses 1 to 15.
19. A method of handling data in a processor, the method comprising:
   obtaining task data that describes a task to be executed, the task comprising a plurality of operations representable as a directed graph of operations comprising operations connected by connections corresponding to respective logical storage locations, such that a first connection associated with a first output of a first operation of the plurality of operations corresponds to a first logical storage location and a second connection associated with a second output of a second operation of the plurality of operations corresponds to a second logical storage location; and
   dynamically allocating:
      a first set of a plurality of storage elements of the storage unit to correspond to the first logical storage location; and
      a second set of the plurality of storage elements of the storage unit to correspond to the second logical storage location.
20. The method of clause 19, comprising dynamically scheduling the first operation and the second operation such that at least part of the first output is written to the first set during writing of at least part of the second output to the second set.

What is claimed is:

1. A processor for handling data, the processor comprising a storage unit comprising a plurality of storage elements, the processor configured to:
obtain task data that describes a task to be executed, the task comprising a plurality of operations representable as a directed graph of operations comprising operations connected by connections corresponding to respective logical storage locations, such that a first connection associated with a first output of a first operation of the plurality of operations corresponds to a first logical storage location and a second connection associated with a second output of a second operation of the plurality of operations corresponds to a second logical storage location; and
dynamically allocate:
a first set of the plurality of storage elements of the storage unit to correspond to the first logical storage location; and
a second set of the plurality of storage elements of the storage unit to correspond to the second logical storage location.

2. The processor of claim 1, wherein the task data is indicative that the first logical storage location is associated with a logical storage area and the second logical storage location is associated with the logical storage area, and the processor is configured to allocate the storage unit to correspond to the logical storage area based at least partly on the task data.

3. The processor of claim 1, wherein the processor is configured to dynamically allocate the first set and the second set such that, at a given time, the first set is disjoint from the second set.

4. The processor of claim 1, wherein at least one storage element of the second set is disposed between a first storage element of the first set and a second storage element of the first set within the storage unit.

5. The processor of claim 1, wherein the processor comprises execution circuitry and a handling unit, and the handling unit is configured to dynamically schedule the first operation and the second operation for execution by the execution circuitry such that at least part of the first output is written to the first set during writing of at least part of the second output to the second set.

6. The processor of claim 1, wherein the processor comprises execution circuitry and a handling unit, and the handling unit is configured to instruct execution of the first operation by the execution circuitry in response to determining that at least one of:
a logical source storage area for storing source data to be processed during execution of the first operation comprises valid source data for storing source data to be processed during execution of the first operation comprises valid source data;
the storage unit comprises an available storage element of the plurality of storage elements available for storage of data therein, wherein the available storage element is at least one of: allocated to the first set or available for allocation to the first set; and
a logical destination storage area is available for storing a further output to be generated during execution of a first consumption operation of the plurality of operations comprising at least partial reading of the first output.

7. The processor of claim 1, wherein the processor comprises execution circuitry and a handling unit, and the handling unit is configured to dynamically schedule, for execution by the execution circuitry, a first consumption operation comprising at least partial reading of the first output and a second consumption operation comprising at least partial reading of the second output.

8. The processor of claim 1, comprising a handling unit configured to:
track usage of the plurality of storage elements during execution of the task; and
dynamically allocate the first set and the second set at least partly based on the usage tracked by the handling unit.

9. The processor of claim 8, wherein the handling unit is configured to:
dynamically schedule the first operation to sequentially write portions of the first output to respective storage elements of the first set in a first order, at least partly based on the usage tracked by the handling unit; and
generate order data indicative of the first order.

10. The processor of claim 9, wherein the order data comprises pointers for respective storage elements of the first set such that a given pointer for a given storage element of the first set points to a location of a successive storage element of the first set, to be written to successively after the given storage element, according to the first order.

11. The processor of claim 9, wherein the first order is represented as a linked list.

12. The processor of claim 11, wherein to track the usage of the plurality of storage elements comprises tracking a head of the linked list.

13. The processor of claim 11, wherein the handling unit is configured to schedule at least partial reading of the first output by at least one consumption operation of the plurality of operations and to track the usage of the plurality of storage elements comprises tracking a respective tail of the linked list for each of the at least one consumption operation.

14. The processor of claim 8, wherein to track the usage of the plurality of storage elements comprises generating storage element characteristic data for a given storage element of the plurality of storage elements indicating, at a given time, at least one of:
whether the given storage element is allocated to a logical storage location of a plurality of storage locations comprising the first logical storage location and the second logical storage location;
the logical storage location to which the given storage element is allocated, if the given storage element is allocated to the logical storage location;
whether the given storage element is available for data to be written thereto; and
whether the given storage element is storing valid data to be read therefrom.

15. The processor of claim 8, wherein to track the usage of the plurality of storage elements comprises generating operation characteristic data indicating, at a given time, at least one of:
a logical destination storage area for storing a further output to be generated during execution of a first consumption operation of the plurality of operations comprising at least partial reading of the first output; and
an availability of the logical destination storage area for storing the further output.

16. A system comprising:
the processor of claim 1, implemented in at least one packaged chip;
at least one system component; and
a board,
wherein the at least one packaged chip and the at least one system component are assembled on the board.

17. A chip-containing product comprising the system of claim 16, wherein the system is assembled on a further board with at least one other product component.

18. A non-transitory computer-readable medium having stored thereon computer-readable code for fabrication of the processor of claim 1.

19. A method of handling data in a processor, the method comprising:
obtaining task data that describes a task to be executed, the task comprising a plurality of operations representable as a directed graph of operations comprising operations connected by connections corresponding to respective logical storage locations, such that a first connection associated with a first output of a first operation of the plurality of operations corresponds to a first logical storage location and a second connection associated with a second output of a second operation of the plurality of operations corresponds to a second logical storage location; and
dynamically allocating:
a first set of a plurality of storage elements of the storage unit to correspond to the first logical storage location; and
a second set of the plurality of storage elements of the storage unit to correspond to the second logical storage location.

20. The method of claim 19, comprising dynamically scheduling the first operation and the second operation such that at least part of the first output is written to the first set during writing of at least part of the second output to the second set.
